(19) United States
(12) Patent Application Publication
(10) Pub. No.: US 2002/0124185 A1
(43) Pub. Date: Sep. 5, 2002

(54) Methods and systems to detect unauthorized software

(76) Inventor: Gil Caspi, Hadera (IL)

Correspondence Address: Hugh D. Jaeger, Hugh D. Jaeger, PA, Suite 302, 1000 Superior Blvd., Wayzata, MN, 55391-1873, US

(21) Appl. No.: 09/799,178

(22) Filed: Mar. 5, 2001

(51) Int. Cl. G06F 11/30

(52) U.S. Cl. 713/201

(57) ABSTRACT

There are disclosed methods and systems for detecting unauthorized software. These methods and systems operate by querying domain name servers for data representative of software and the machine (computer) of a user employing the software, that is released to networks in packetized transmissions by these user machines, and travels through these domain name servers. If this data representative of the software and the machine employing the software is detected in the packetized transmission, it is extracted and compared against previously stored data. Once the comparison is complete, an authorization status (authorized or unauthorized) for the software is determined, and if an unauthorized status is determined, unauthorized software has been detected.

### FIELD OF THE INVENTION

The present invention is directed to methods and systems for detecting unauthorzed software and its use.

### BACKGROUND OF THE INVENTION

The Software Industry is the fastest growing segment of the computer industry. Potential revenues are enormous, however, billions of dollars in revenue are lost every year due to unauthorized software and/or unauthorized uses thereof.

Unauthorized software, and unauthorized uses thereof, can be from both legal and illegal copies of the requisite software. Unauthorized software may be from a legal copy, that upon its transport and placement into a second computer, different from the original or first computer, typically renders it unauthorized software, as per the license agreement, with its use in this second computer unauthorized. Unauthorized software is also illegally copied and “pirated” software, and its use is accordingly unauthorized

Unauthorized software, as defined above, and uses thereof, are normally detected in a users computer via cookies. Cookies are code, aplets or portions thereof, sent over a network, typically the Internet, by the software providers, that ultimately reach the users browser, when the user accesses the providers web site. Once in the user's browser, the cookies function to detect this unauthorized use or illegally copied software, by sending transmissions to the provider over the internet.

There is a drawback in using these cookies, for they must first get into the user's computer via the browser. Accordingly, if a user has a strong firewall, the cookies may never get into the browser and the unauthorized software and its use may never be known.

### SUMMARY OF THE INVENTION

The present invention improves on the contemporary art by providing methods and systems for detecting unauthorized software These methods and systems operate by querying Domain Name Servers (DNS or DNS servers) for data representative of software and the machine or computer of a user employing the software, that is released to networks in packetized transmissions by these user machines, and travels through these domain name servers. If this data representative of the software and the machine or computer employing the software is detected in the packetized transmission, it is extracted and compared against previously stored data. Once the comparison is complete, an authorization status (authorized or unauthorized) for the software is determined, and if an unauthorized status is determined, unauthorized software has been detected. The invention does not require cookies or other programs implanted, imported or sent into a users machine or computer.

The present invention provides a method for detecting unauthorized software by providing at least one query to at least one Domain Name Server for at least one packetized transmission. and analyzing the packetized transmission, typically at the fourth packet in sequential order of a typically sixteen packet transmission, for predetermined data therein. This predetermined data at least includes “operating data”, that is, for example, the combination of “software data”, such as data corresponding to the software itself, and “machine data”, such as data corresponding to components (hardware) of the user machine or computer, employing the software. The predetermined data, for example, the “operating data”, is then extracted from the at least one packetized transmission, typically the fourth sequentially ordered packet of the sixteen packet packetized transmission. This data is then compared with corresponding stored data, and as a result of this comparison, the authorization status (authorized or unauthorized) of the software is determined.

This determination of the authorization status, may be transmitted to a customer, over a network, such as the Internet. The transmission is typically accompanied by the session number of the initial packetized transmission from the user machine to the DNS server, so that the customer can trace the unauthorized software to the user machine, via the user machine's Internet Service Provider (ISP). This typically occurs in the case when the authorization status determined is unauthorized, whereby unauthorized software has been detected in a user machine, allowing the customer to inform the user machine that software therein is unauthorized.

Another embodiment of the present invention is directed to a system for detecting unauthorized software. This system includes a server for communication with at least one user machine via a domain name server and for positioning on a network. The server includes a storage medium, such as a data warehouse, and a processor The processor is programmed to provide at least one query to at least one Domain Name Server for at least one packetized transmission, and analyze the at least one packetized transmission, for example, typically at the fourth sequentially ordered packet of a typical sixteen packet transmission, for predetermined data therein, with this predetermined data at least including data corresponding to the software and the at least one machine using the software therein. The processor is then programmed to extract this predetermined data from the at least one packetized transmission, for example, the fourth packet in sequential order, compare the extracted predetermined data from the at least one packetized transmission with corresponding stored data, and determine the authorization status of the software in accordance with the comparison.

When an authorization status of unauthorized is determined, unauthorized software has been detected. In particular, it has been detected on the user machine, that sent the packetized transmission. This determination of unauthorized software being detected may be transmitted to a customer, over a network, such as the Internet. The transmission is typically accompanied by the session number of the initial packetized transmission from the user machine to the DNS server, so that the customer can trace the unauthorized software to the user machine. via the user machine's Internet Service Provider (ISP).

In another embodiment of the invention, there is disclosed a programmable storage device readable by a machine, tangibly embodying a program of instructions executable by a machine to perform method steps for detecting unauthorized software, these method steps selectively executed during the time when the program of instructions is executed on the machine. The program of instructions includes providing at least one query to at least one Domain Name Server for at least one packetized transmission sent from a machine using software therein, analyzing the at least one packetized transmission for predetermined data therein, where the predetermined data at least includes data corresponding to the software and the machine using the software therein. The program of instructions also includes extracting the predetermined data from the at least one packetized transmission, comparing the extracted predetermined data with corresponding stored data, and determining the authorization status (authorized or unauthorized) of the software in accordance with the comparison.

### BRIEF DESCRIPTION OF THE DRAWINGS

The present invention will be described with respect to the accompanying drawings, where like reference numerals or characters identify corresponding or like components. In the drawings:

FIG. 1 is a diagram of an embodiment of the present invention in use in an exemplary applicationFIG.

FIG. 2 is a flow diagram of a process in accordance with an embodiment of the present invention; and

FIG. 3 is a flow diagram of an additional process in accordance with an embodiment of the present invention when unauthorized software is detected.

### DETAILED DESCRIPTION OF THE DRAWINGS

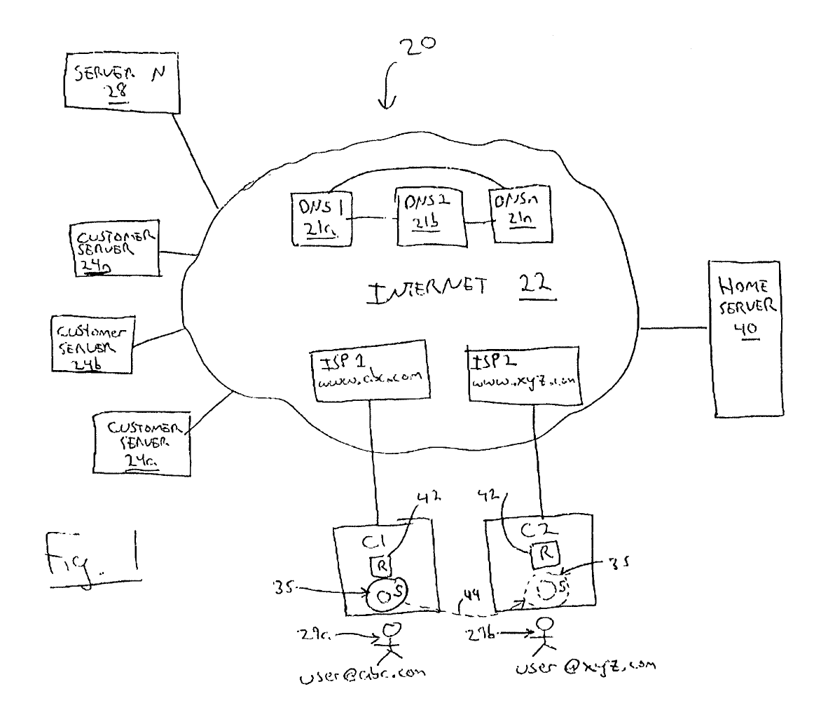

FIG. 1 shows an exemplary system 20, where the network employed is, for example, a wide area network (WAN), such as the Internet 22. Various servers and components, detailed below, sit on or along the Network. Any number of these servers and components, may be on or along the network Accordingly, the arrangement of servers and components, as shown and described below, is exemplary of the types of servers and components, useful when describing the present invention. Domain Name Servers (DNS) (hereinafter “DNS Servers”) 21a-21n, sit on the Internet 22, as does at least one Customer Server (CS) 24a-24n, as well as other, third party servers 28, for example, server N. Users 29a, 29b, through their respective machines or computers C1 and C2 (two users shown here for example, but could be any number), connect to the Internet 22, through their respective Internet Service Providers (ISPs), indicated by ISP1 and ISP2 (they could also have the same ISP). Computers C1 and C2 are capable of using software (S) 35 (also known herein as a software program, formed of either single or multiple programs), that, for example, could be on any conventional data storage media, such as a compact disc (CD) or the like.

In one embodiment, the present invention is employed via the Home Server 40. This home server 40 sits on or along the Internet 22 in communication with all of the aforementioned servers and ISP's, as well as other conventionally networked servers and components.

The DNS servers 21a-21n translate domain names to Internet Protocol (IP) addresses. For example, the domain name www.abc.com, translates to numbers, such as 197.134.454.8. These DNS servers 21a-21n are also configured for receiving messages from other servers, as well as other DNS servers, and can evaluate packetized transmissions traveling over the Internet 22. The arrangement of DNS servers is such that they form their own network This is because should one DNS server not know how to translate a particular domain name, it will query another DNS server, and so on. until the correct IP address is returned.

The customer servers 24a-24n are servers operated by customers or potential customers of the service provided by the home server 40. Accordingly, the customers may typically be software manufacturers, distributors, providers, or the like.

The machines or computers C1 and C2 (of the users 29a, 29b) are, for example, workstations, personal computers (PC), or the like, that employ operating systems, typically the Windows® Operating System from Microsoft, Inc., Redmond, Wash. These computers C1, C2 also have a registry R 42. This registry R 42 is a database used by the WVindows® Operating System to store configuration information about the respective computer, and compress data, corresponding to information about the machine or computer, e.g., hardware, and software used therein. collectively, known as “operating data”. The registry R 42 then places this compressed operating data into packets, that form portions of packetized transmissions. These packetized transmissions are sent to the DNS servers 21a-21n when the user of the respective computer, for example computer C1 connects to the Internet 22 via his ISP, here ISP1.

Most Windows® applications write data to the registry R, for example, the software registry, at least during installation of the requisite software. These computers C1 and C2 are exemplary of different computers, each with components unique to each of them. The “operating data” written into the registry R 42 includes “machine data” and “software data”. “Machine data” is the data associated with computer or machine components, e.g., hardware (of the user computer or machine operating the requisite software), and typically includes serial numbers of components of the individual specific (user's) computer or machine, such as the serial numbers of the hard disc, CD Drive, DVD Drive, processor, modem, Ethernet card, PC board. “Software data” is the data associated with the software, and typically includes serial numbers, registration numbers and/or product numbers of software and other programs either preloaded, downloaded or uploaded into the users computer or machine.

For example, one combination of “operating data”, for performing the present invention includes data corresponding to serial numbers for the hard disc, Ethernet card and PC board, forming the “machine data”, and the serial and registration numbers of the requisite software, forming the “software data”. Once received in the registry, these numbers for the “operating data” (“software” and “machine” data), are compressed, typically into 138 bytes (typically in binary), and loaded onto one or more packets of packetized transmission.

Each packetized transmission is typically of sixteen packets in length, in a sequential order, designated PACKET 0 to PACKET 15. The “operating data”, now compressed, is typically loaded onto a single packet, and particularly the fourth packet (in sequential order), known as PACKET 3, of a typical sixteen packet transmission.

The Registry R 42 is configured to send packetized transmissions to the respective ISP upon making a connection thereto. Each packet includes different information. PACKET 3 typically includes the compressed “operating data”, as detailed above, that has been loaded onto this packet by the registry R in forming one of its packetized transmissions.

Home Server 40, facilitates one embodiment of present invention. This Home Server 40, may be any server that collects all Internet queries and functions as a huge data warehouse, as detailed below. This server 40 includes conventional storage media for storing data bases and the like, as well as processors capable and other conventional components capable of running comparison programs. For example, the home server 40 may be a Microsoft® SQL Server (SQL 7 Server).

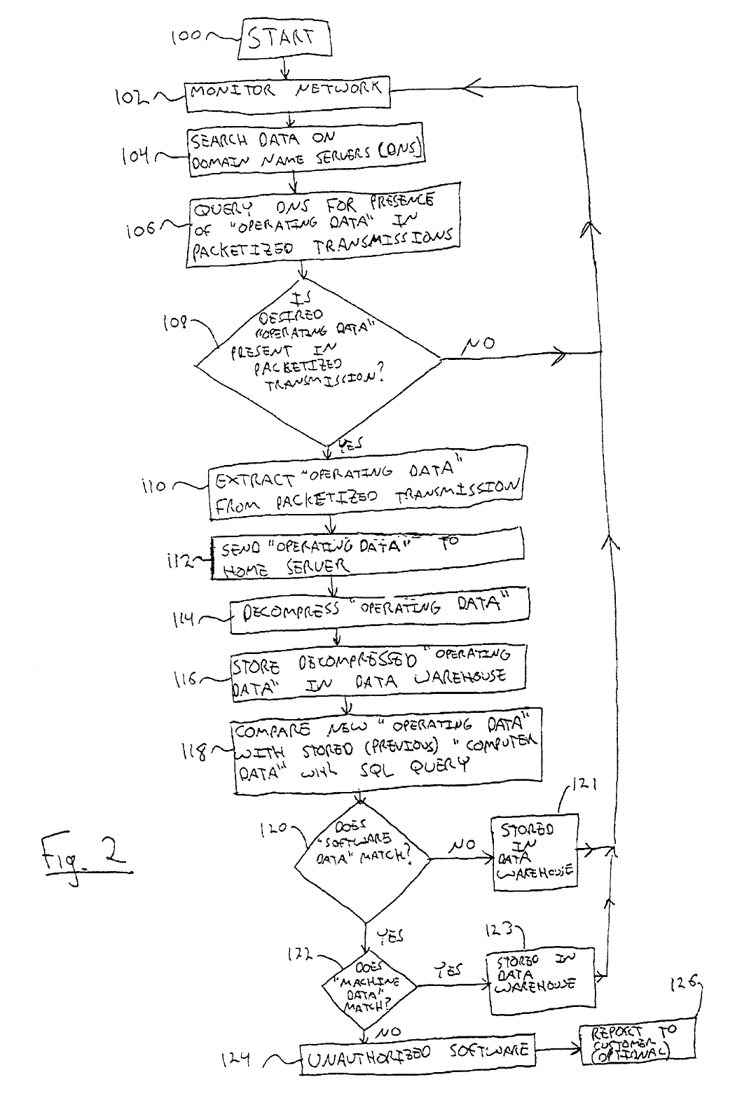

Turning also to FIG. 2, an operation of the present invention will now be described by way of a flow diagram. This process detects unauthorized software by determining the authorization status (authorized or unauthorized) of the requisite software (or software program as detailed above). 15 The process starts at block 100, labeled START. At block 102, the home server 40 monitors the network, here, the Internet 22.

The home server 40 then searches ports on the network for the DNS servers 21a-21n, at block 104. In particular, the Home Server 40 then searches for data on the DNS Servers by querying all of the DNS Servers, typically one by one, to examine all PACKET 3's in all transmissions going through each DNS server, for the above described compressed “operating data”, at block 106, checking if the “operating data” is present in PACKET 3 of the packetized transmission, at block 108.

If the compressed “operating data” is not present on the PACKET 3 of the examined packetized transmission through any of the DNS Servers, the server 40 returns to monitoring the network at block 102. If the compressed “operating data” is present in the examined PACKET 3 of the examined packetized transmission, it is extracted from the PACKET 3. at block 110, and sent to the server 40, at block 112.

The server 40 typically receives the compressed “operating data” with a session number on the shield from the sendirng DNS server. This session number is an Internet Protocol (IP) number, assigned by the TCP/IP Protocol, and is unique to the session associated with the specific packetized transmission, It includes information such as the ISP making the transmission, the date and the time of the transmission, typically via a timestamp.

The server 40 typically decompresses (with conventional decompressing hardware, software or combinations thereof) this received compressed “operating data”, at block 114, and stores the now decompressed “operating data,” along with the session number from the shield, in a data warehouse (storage media) in the server 40 at block 116. This new “operating data” is now compared with previous “operating data” stored in the data warehouse via an SQL query, at block 118.

Initially, the “software data”, typically including the license and/or registration numbers for the requisite software being examined, are compared at block 120. If the “software data” is different, the software is determined to have an authorization status (authorized or unauthorized) that is authorized, whereby this new decompressed “operating data” is stored in the data warehouse of the server 40. at block 121, The server 40 returns to monitoring the network, at block 102.

If the “software data”, e.g. one or both of these numbers is the same, or one number in the case of only one software number being utilized, data as to the machine (the “machine data” as detailed above), is compared, at block 122. This “machine data”, at a minimum. typically includes the serial numbers of the hard disc, Ethernet Card and PC Board (checksum).

If the “machine data” matches. the software has an authorization status determined to be authorized, and this new decompressed “operating data” is stored in the storage media, here, the data warehouse of the home server 40, at block 123. The home server 40 returns to monitoring the network, at block 102. However, if the “machine data”, does not match, the software has an authorization status that is determined to be unauthorized at block 124, whereby unauthorized software has been detected. This detection of unauthorized software may be indicated by the sending of messages or the like. For example, the home server 40 may send a message (of the unauthorized software), such as an automatically generated electronic mail document, to the computer of the server operator, who will send a message to the customer server 24a-24n as detailed below. This process can also be automatic.

This new decompressed “operating data” is stored in the data warehouse. The home server 40 may now optionally begin a reporting, informing the software maker, producer, distributor of this unauthorized software and the user thereof, at block 126.

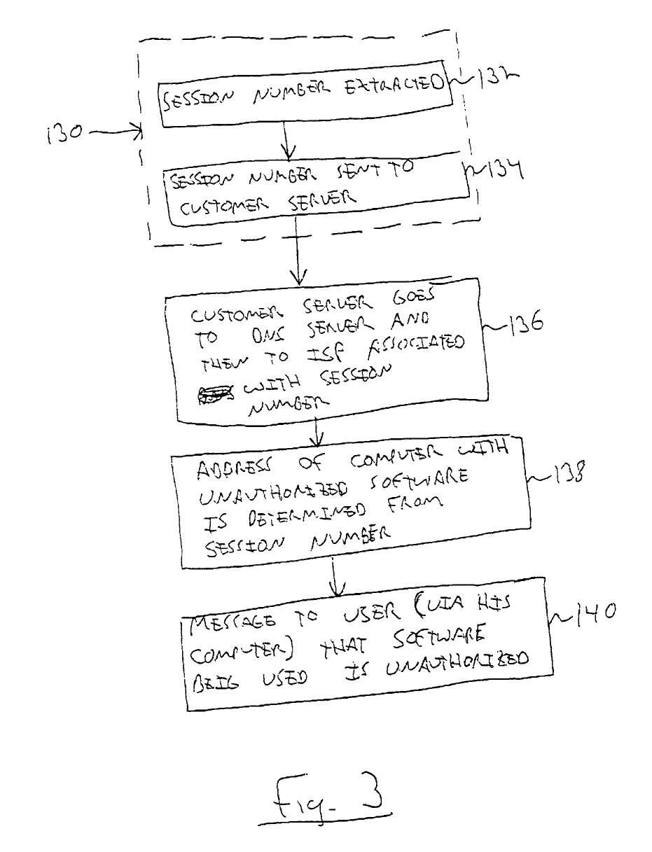

Turning also to FIG. 3. there is detailed the reporting process of block 126 via the Internet 22, at block 130. Since reporting will be over the Internet 22, the software maker, producer, distributor, etc. that desires to know about unauthorized software is represented by customer servers 24a-24n, and for exemplary purposes the concerned software entity is customer server 24a.

As the result of a match between the new “operating data” and at least one stored “operating data”, the session number from the shield associated with the new “operating data” is extracted at block 132. It is then sent to the customer server 24a, at block 134. The customer, owner or operator of the customer server 24a, then uses the session number to go to the requisite DNS Server and then to the ISP from which the transmission with the requisite PACKET 3 was sent, at block 136. The computer address, for example, the address of the first computer C1. for the unauthorized software can then be determined through the ISP for computer C1, here ISPI with an address of abc.com, at block 138. With this computer address, for example, a user name with this domain, such as user@abc.com, can be sent a message by the customer server 24a that software S 35 is unauthorized software, at block 140, to the user 29a.

Similarly, should unauthorized software be detected in the second computer C2, for example, either a legal (authorized) copy or an illegal (unauthorized) copy in the first computer C1 that was transported to this second computer C2 (indicated by broken line arrow 44 and software S 35 in broken lines), the above-described process remains the same. However, here, for example, to better illustrate the invention, the second computer C2 has an ISP, here ISP2, of a different domain, such as xyz.com. (Computer C2 may also have the same ISP as the first computer, but the user 29b in this case would have a different name, such as c2user@abc.com). Accordingly, the customer server 24a will send a message to the user 29b of this second computer C2, through the ISP, here ISP2, that the software is unauthorized at the user 29b at userxyz.com.

In alternate embodiments, the above detailed process could be programmed onto a program storage device, such as a compact disc (CD), floppy disc, magnetic media or the like, readable by a machine, computer or the like, tangibly employing a program of instructions executable by a machine, computer or the like, for installation on the customer servers 24a-24n, that could perform the present invention directly, or any other third party server, for example Server N. 28 (FIG. 1) on the Internet 22. The corresponding program of instructions for executing the present invention. if placed on a third party server 28 can be downioadable from this third party server 28.

The methods and apparatus disclosed herein have been described with exemplary reference to specific hardware and/or software. The methods have been described as exemplary, whereby specific steps and their order can be omitted and/or changed by persons of ordinary skill in the art to reduce embodiments of the present invention to practice without undue experimentation. The methods and apparatus have been described in a manner sufficient to enable persons of ordinary skill in the art to readily adapt other commercially available hardware and software as may be needed to reduce any of the embodiments of the present invention to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for detecting unauthorized software comprising:
providing at least one query to at least one Domain Name Server for at least one packetized transmission sent from a machine using software therein;
analyzing said at least one packetized transmission for predetermined data in said at least one packetized transmission, said predetermined data at least including data corresponding to said software and said machine using said software therein;
extracting said predetermined data from said at least one packetized transmission;
comparing said extracted predetermined data from said at least one packetized transmission with corresponding stored data; and
determining the authorization status of said software in accordance with said comparison.

2. The method of claim 1, wherein said analyzing said at least one packetized transmission includes analyzing at least one packet of said packetized transmission for said predetermined data.

3. The method of claim 2, wherein said analyzing at least one packet of said packetized transmission includes analyzing the fourth packet in sequence of said at least one packetized transmission for said predetermined data.

4. The method of claim 1, additionally comprising:
receiving a session number associated with said at least one packetized transmission to said Domain Name Server.

5. The method of claim 4, additionally comprising:
transmitting said session number and a report corresponding to an indication that said software is unauthorized, to a network, for transmission to at least one customer server.

6. The method of claim 1, additionally comprising:
storing said extracted predetermined data in a storage media.

7. The method of claim 1, wherein said predetermined data including data corresponding to said software at least includes data representative of the license number and the registration number of said software.

8. The method of claim 1, wherein said predetermined data including data corresponding to said machine using said software at least includes data representative of the hard disc, PC board and Ethernet card of said machine.

9. A system for detecting unauthorized software comprising:
a server for communication with at least one user machine via a domain name server and for positioning on a network, said server comprising:
a storage medium; and
a processor, said processor programmed to:
provide at least one query to at least one Domain Name Server for at least one packetized transmission;
analyze said at least one packetized transmission for predetermined data in said at least one packetized transmission, said predetermined data at least including data corresponding to said software and said at least one machine using said software therein;
extract said predetermined data from said at least one packetized transmission;
compare said extracted predetermined data from said at least one packetized transmission with corresponding stored data; and
determine the authorization status of said software in accordance with said comparison.

10. The system of claim 9, wherein said processor is programmed to analyze said at least one packetized transmission by being further programmed to analyze at least one packet of said packetized transmission for said predetermined data.

11. The system of claim 9, wherein said processor is programmed to analyze at least one packet of said packetized transmission by being further programmed to analyze the fourth packet in sequence of said at least one packetized transmission for said predetermined data.

12. The system of claim 9, wherein said processor is additionally programmed to:
obtain a session number associated with said at least one packetized transmission to said Domain Name Server.

13. The system of claim 12, wherein said processor is additionally programmed to:
transmit said session number and a report corresponding to an indication that said software program is not authorized to a network, for transmission to at feast one customer server.

14. The system of claim 9, wherein said processor is additionally programmed to:
store said extracted predetermined data in said storage media.

15. The system of claim 9, wherein said storage medium includes at least one data warehouse.

16. The system of claim 11, wherein said processor is programmed to analyze fourth packet in sequence of said at least one packetized transmission for said predetermined data, by being additionally programmed to obtain said predetermined data including data representative of said software program and said at least one machine, from said fourth packet.

17. The system of claim 16, wherein said processor is additionally programmed to obtain data representative of said software program from said fourth packet by obtaining at least data representative of the license number and the registration number of said software.

18. The system of claim 16, wherein said processor is additionally programmed to obtain data representative of said at least one machine from said fourth packet by obtaining at least data representative of the hard disc, PC board and Ethernet card of said machine using said software therein.

19. A programmable storage device readable by a machine, tangibly embodying a program of instructions executable by a machine to perform method steps for detecting unauthorized software, said method steps selectively executed during the time when said program of instructions is executed on said machine, comprising:
providing at least one query to at least one Domain Name Server for at least one packetized transmission sent from a machine using software therein;
analyzing said at least one packetized transmission for predetermined data in said at least one packetized transmission, said predetermined data at least including data corresponding to said software and said machine using said software therein;
extracting said predetermined data from said at least one packetized transmission;
comparing said extracted predetermined data from said at least one packetized transmission with corresponding stored data; and
determining the authorization status of said software in accordance with said comparison.
